(19) United States
(12) Patent Application Publication
(10) Pub. No.: US 2014/0070475 A1
(43) Pub. Date: Mar. 13, 2014

(54) KEBAB DE-SKEWER

(71) Applicant: Mansoor Ghazizadeh, Los Gatos, CA (US)

(72) Inventor: Mansoor Ghazizadeh, Los Gatos, CA (US)

(21) Appl. No.: 13/926,494

(22) Filed: Jun. 25, 2013

Related U.S. Application Data
(60) Provisional application No. 61/743,679, filed on Sep. 10, 2012.

(51) Int. Cl. A47J 45/10

(52) U.S. Cl. CPC A47J 45/10
USPC 269/257

(57) ABSTRACT

A kebab de-skewer includes a first tray sized to receive skewered kebab pieces. The kebab de-skewer also includes a second tray and a handle. The handle is connected to the first and second tray so that when the handle is in an open position there is enough separation between the first tray and the second tray so that a kebab can be loaded into the first tray. When the handle is placed in a closed position, the second tray is held against skewered kebab pieces so that a user can remove a skewer from the skewered kebab pieces, leaving the kebab pieces in the first tray.

### BACKGROUND

Kebab is a popular dish in the Middle East regions of the world and in western countries as well. Typically a kebab consists of meat and/or vegetable placed on skewer and grilled over fire. It is often served with bread or rice. Common meats used in kebabs include lamb, beef, chicken, turkey, fish, goat meat, wild game meat, and so on. Kebab pieces are either put on skewer as ground meat (called Kabab Koobideh in Persian) or meat chunks (named Kabab Barg or Shish Kabab in Persian). Vegetables such tomato, onion, pepper, squash, and others are usually cut to chunks and skewered as well. Herein below, ground meat, solid chunk meat, vegetable or combination of meet and vegetable will be generically referred to as kebab pieces.

Traditionally kebab pieces, after being cooked, are pulled from a skewer by hand. Sometimes, the skewer with kebab pieces is placed between pieces of bread and held with one hand while the other hand pulls out the skewer. A utensil such as a fork or a knife can also be used to pull or slide kebab pieces off a skewer piece by piece or all at one time. A glove or a towel can also be used, offering protection from burns when kebab pieces are hot.

When removing kebab pieces from a skewer, several issues can arise. For example, the kebab pieces and the skewer can be very hot and difficult to handle with a bare hand. A hand burn can result from pulling a skewer out of kebab pieces.

If kebab pieces cook unevenly, for example, as the result of fire under the kebab pieces not being uniform, kebab pieces at one end of the kebab can overcook or burn and stick to the skewer. When the skewer is pulled out of the kebab pieces, kebab pieces can fold and crumble. This is can especially be a problem with ground meat (Kabab Koobideh). Also, when kebab pieces are handled by a soiled hand directly, with a soiled glove or with a soiled towel, the kebab pieces can be come contaminated.

Barbequing with skewers have a lot of benefits and is an ancient way of cooking food. There many types of skewers, wooden, metal, bamboo, short, long, wide, narrow, with handle without handle. In regions of the world that barbequing with skewers is the main way of barbequing, the barbeque grills are designed to handle skewers of a specific kind.

In Middle East and parts of Asia, long skewers (e.g., twelve to fifteen inches) are popular. Grills used to barbeque are typically a fire pit container holding charcoal burns. Skewers rest on the front and back lip of the charcoal pit container so that skewered food does not touch the cooking grate or the heat source. Heat from below the skewer cook the skewered food while the chef can rotate the skewer for even cooking. In Japan and other parts of Asia, where smaller skewers (e.g., six to eight inches) are popular, the fire pit container is narrower, but the process of barbequing is the same.

In Western countries, where skewer cooking is not a dominant way of cooking, a standard BBQ grill with grates on top is often used for cooking skewered food. Skewer cooking on a grill with grates introduces multiple issues. For example, skewered food will touch the grates and will cause the food to stick to the grill and can be pulled off the skewer when it is attempted to be remove the skewered food from the grill. This can be especially troublesome for softer meat like seafood meat or ground meat that is wrapped around the skewer. Also, when skewer cooking on a grill, the skewer ends can heat up and will difficult to touch. In case of wood skewers, the skewer ends that are exposed sometimes burn and be difficult to handle post cooking. In case of metal skewers, the end can get hot and be unsafe to touch for rotation and removal.

### BRIEF DESCRIPTION OF THE DRAWINGS

FIG. 1, FIG. 2, FIG. 3, FIG. 4, FIG. 5 and FIG. 6 show various views of a kebab de-skewer in accordance with an embodiment.

FIG. 7 and FIG. 8 illustrate use of a sleeve as part of a kebab de-skewer in accordance with an embodiment.

FIG. 9, FIG. 10, FIG. 11 and FIG. 12 illustrate use of a kebab de-skewer to de-skewer a kebab in accordance with an embodiment.

FIG. 13, FIG. 14, FIG. 15 and FIG. 16 show various views of a kebab de-skewer in accordance with an alternate embodiment.

FIG. 17 and FIG. 18 show various views of a kebab de-skewer in accordance with another alternate embodiment.

FIG. 19, FIG. 20 and FIG. 21 illustrate a tong locking mechanism in accordance with another alternate embodiment.

FIGS. 22 and 23 show a skewer grip in accordance with an embodiment.

FIGS. 24 and 25 show a skewer grip in accordance with another embodiment.

FIG. 26 shows one side of a skewer rack in accordance with an embodiment.

FIG. 27 shows an assembled skewer rack in accordance with an embodiment.

### DESCRIPTION OF THE EMBODIMENT

A kebab de-skewer (Kabab-Kesh in Persian—literally meaning kebab puller) is presented herein. The kebab de-skewer is useful for de-skewering all kinds of meats and vegetables from a skewer. This includes de-skewering ground meat kebab (Kabab Kobideh), a kebab of thin wide strips of beef meat (Kabab Barg), a kebab of chunky chicken meat (Joojeh Kabab), a chunky meat kebab (Shishlik), fish kebab, vegetable kebab, and so on. For example, the size and configuration of a kebab de-skewer can be optimized to handle different types and sizes of kebabs.

The kebab de-skewer is designed to pull the kebab pieces (i.e., meat and/or vegetables) from the skewer and hold the kebab pieces in their completeness and original shape for placing in a serving dish. For example, a kebab de-skewer includes a tong handle and a tray at each end of the tong. For example, the tong handle may be spring loaded.

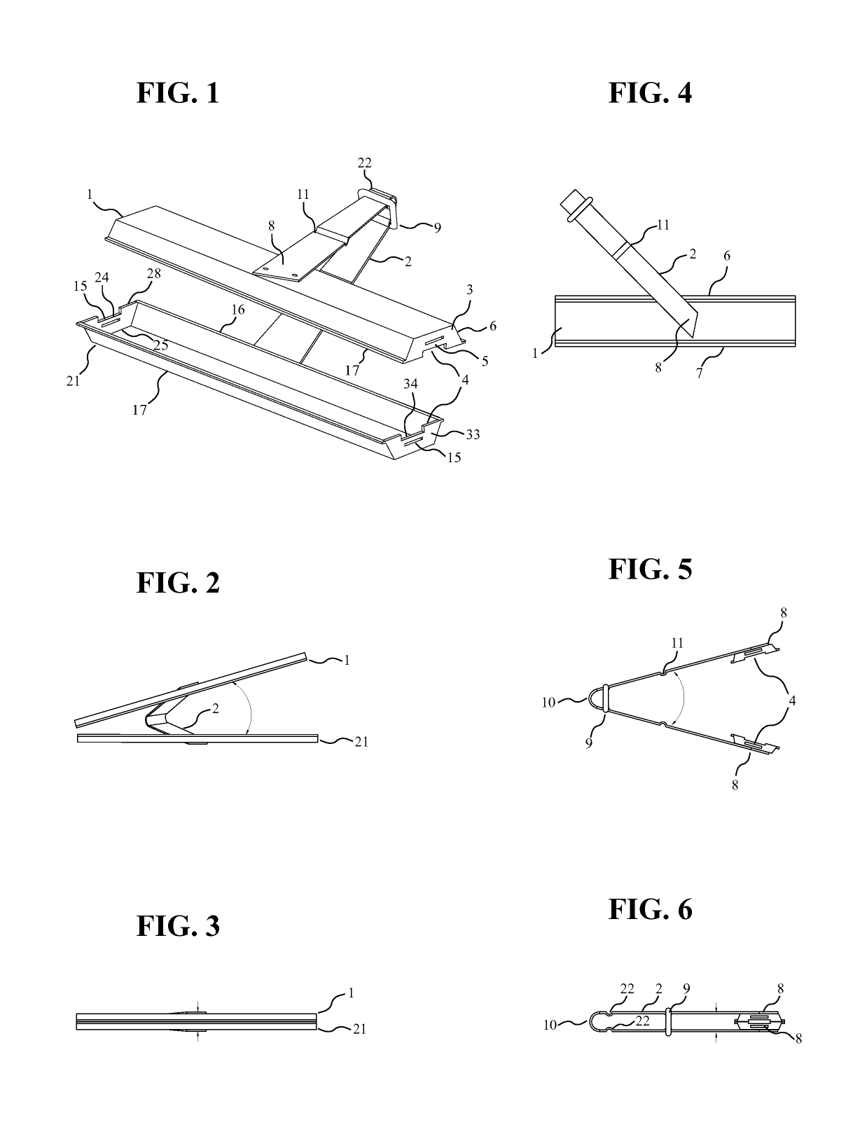

FIG. 1 shows a spring loaded tong handle 2 attached to a top tray 1 at a tong end 8 and a bottom tray 21 at another tong end of tong handle 2. For example, tong end 8 is attached to top tray 1 using rivets, screws, soldering, brazing, welding or some other means of attachment. The other tong end is similarly attached to bottom tray 21. Tong handle 2 brings top tray 1 and bottom tray 21 in contact with kebab pieces on a skewer. Top tray 1 and bottom tray 21 hold kebab pieces in place while a skewer is pulled out from the kebab pieces.

For example, top tray 1 and bottom tray 21 each have a rectangular shape and are sufficiently long to hold all the kebab pieces intended to be placed on a skewer. Top tray 1 and bottom tray 21 may be identical in construction. Alternatively, bottom tray 21 may be sturdier than top tray 1 so that bottom tray 21 has the strength to hold the kebab weight without any bend along the length of bottom tray 21 when supporting the weight of a skewer and kebab pieces. Top tray 1, to save cost, can be made less sturdy then bottom tray 21 when top tray 1 is not used to support the weight of a skewer and kebab pieces.

The kebab pieces can be placed on bottom tray 21. A user can squeeze tong handle 2 to bring top tray 1 into contact with kebab pieces. Enough pressure is placed squeezing tong handle 2 so that a sufficient trapping force is exerted along the length of top tray 1 and bottom tray 21 to hold the kebab pieces when the skewer is pulled out from the kebab pieces.

For example, tong handle 2 is a single piece of bent or formed material that has a spring as the inherent property of a bent end 10. Other types of tongs may be utilized. For example a scissor type tong can be used. Alternatively, a multi-piece spring-type tong could be used that has handle sides connected at one end and uses a spring (compression or torsion) that provides the spring function between the handle sides.

Indentations 22 on tong handle 2, shown most clearly in FIG. 6, are located close to bent end 10 and serve to hold an o-ring 9 when tong handle 2 is in an open position. The position of o-ring 9 when tong handle 2 is in the open position is illustrated by FIG. 5.

Indentations 11 on tong handle 2 are located farther up tong handle 2 and are used to hold o-ring 9 in place so that tong handle 2 is in a locked position. For example, tong handle 2 is in the locked position when being stored and is in the open position when being used. The position of o-ring 9 when tong handle 2 is in the locked position is illustrated by FIG. 6.

When in the open position, the kebab de-skewer can be used to de-skewer kebabs. For example, FIG. 2 shows tong handle 2 being opened and ready to receive a kebab. FIG. 3 shows the kebab de-skewer in a closed position for storage or for de-skewering a kebab.

The connection point of tong handle 2 to top tray 1 and bottom tray 21 can be designed to have a changeable or fixed angle. In a fixed angle configuration, the angle at which tong handle 2 is attached to top tray 1 and bottom tray 21 does not change. The operating angle of the handle to the tray is between zero and ninety degrees. At zero degrees, tong handle 2 is aligned with top tray 1 and bottom tray 21. At ninety degrees, tong handle 2 is perpendicular to top tray 1 and bottom tray 21.

For example, FIG. 4 shows tong handle 2 being attached to top tray 1 and bottom tray 21 at approximately a forty-five degree angle.

Alternatively, tong handle 2 can be attached to top tray 1 and bottom tray 21 in such a way that the angle of attachment can be varied. This can be accomplished, for example, by using a pivot at end 8 to attach tong handle 2 to top tray 1 and a pivot at the other tong end 8 attach tong handle 2 to bottom tray 21. Varying the angle of connection provides use angle customization, and also can allow for a separate storage angle. For example, the storage angle may be approximately zero degrees to reduce the footprint of the kebab de-skewer when being stored. For example the angle can be varied to accommodate a left-handed verses a right-handed user.

The sides of top tray 1 and bottom tray 21 can be folded in to protect the kebab pieces from shifting side to side. For example, the folded tray side can also be used to exert lateral force on the kebab pieces on the skewer and thus keep the kebab pieces in place while a skewer is pulled out. The angle of the fold can be between zero degrees (flat or same as tray plane), and ninety degrees (perpendicular to the tray plane). Each of the sides of top tray 1 and bottom tray 21 can have a different angle of fold. For example, a fold angle of the side farther away from tong handle 2 can be closer to zero so that after skewer extraction, the kebab pieces can easily slid out into the serving dish.

FIG. 1 shows a fold at a side 17 and a fold at side 16 of bottom tray 21. FIG. 1 shows a fold at a side 7 and a fold at a side 6 of top tray 1. The top of each folded side may also have a lip, as shown by FIG. 1. The lip at the top of each folded side serves as a resting place where top tray 1 and bottom tray 21 rest against each other when top tray 1 and bottom tray 21 come in contact with each other when de-skewering a kebab, or when placing the kebab de-skewer in a closed position for storage.

The front and back of bottom tray 21 and/or top ray 1 can be folded inward toward the skewer, creating a wall of folded ends on each side of skewered pieces. These folded ends will be used as blocking walls that separate the kebab pieces from the skewer when the kebab pieces and the skewer are pushed or pulled against them. In a symmetric tray design, the minimum height of the folded ends is approximately equal to the distance between the kebab pieces surface and the skewer.

This is illustrated in FIG. 1 where a wall 3 is shown in top tray 1 and a wall 23 and a wall 33 are shown in bottom tray 21. In this symmetric tray design, when top tray 1 and bottom tray 21 are brought together, a cavity is created with a cavity height that will be approximately equal to the thickness of the kebab pieces. The tray cavity height defined by the folded ends of top tray 1 and bottom tray 21 is sized to contain the kebab pieces and provide a holding force on the kebab pieces without squeezing kebab pieces to an undesirable degree.

For example, a notch may be cut into one or both folded ends of bottom tray 21 or both bottom tray 21 and top tray 1. The notch indentation width is equal or larger than the width of the largest skewer width intended to be used. In its widest form the notch can span across the total width of the folded end edge of the tray. In a symmetric tray design the height of the notch indentation is at minimum equal to half the thickness of the thickest skewer intended to be used. In a non-symmetric tray design the height of the notch indentation in top and bottom tray may be different. The purpose of this notch indentation in the tray ends is to allow for a skewer width and thickness, so when two trays are brought together the contact between tray's folded ends and the skewer is maximized. The notch indentation can also provide skewer placement guidance to the user. This is illustrated in FIG. 1 by a notch 4 shown in top tray 1 and by a notch 24 and a notch 34 shown in bottom tray 21.

The trays of the kebab de-skewer can be fit with sleeves that contain extrusions. The sleeves can customize the tray cavity for size/volume so different sizes of kebab pieces can fit in one common tray cavity. The sleeves can also customize the type of extrusion and extrusion spacing used for different types of kebab pieces. The extrusions can have any shape and can be built into the tray directly without the use of a sleeve. Extrusions can be formed, for example, by folding down notches from the tray. The extrusions prevent kebab pieces from sliding down the tray as the skewer is removed.

The material used for tong handle 2, bottom tray 21 and top tray 1 are, for example, food grade stainless steel or food grade heat resistance plastic that is molded to shape. Stainless steel is used for its durability, heat tolerance and ease to clean. Moldable plastic for top tray 1 and bottom tray 21 or handle 2 can significantly reduce the cost of the kebab de-skewer.

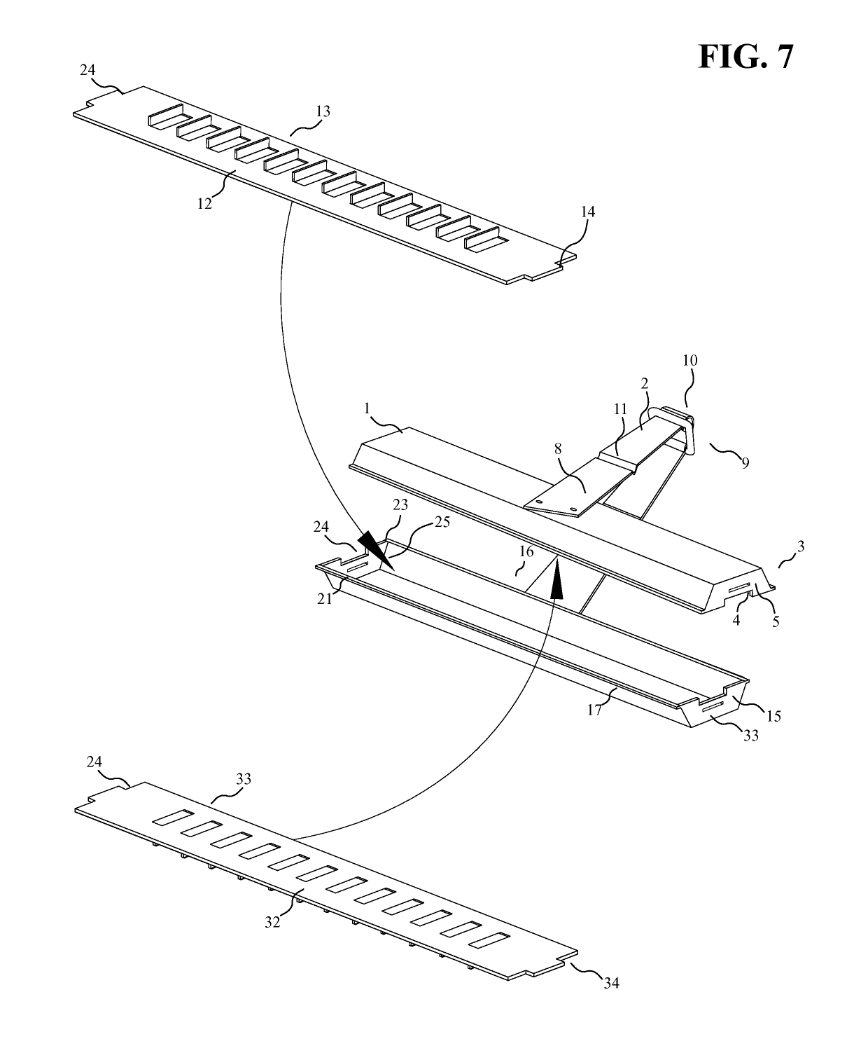

FIG. 7 and FIG. 8 show examples of sleeves with a strip line extrusion. The directions of the extrusions can be perpendicular to the tray plane or have a forward angle toward the front of the tray. FIG. 7 shows a sleeve 12 ready to be placed into bottom tray 21 and a sleeve 22 ready to be placed in top tray 1. Sleeve 12 includes extrusions 13. To assemble, a tab 14 is inserted into a slot 15 in bottom tray 21. A tab 24 is inserted into a slot 25 in bottom tray 21. Sleeve 32 includes extrusions 33. To assemble, a tab 34 is inserted into a slot 5 in top tray 1. A tab 44 is inserted into another slot in top tray 1.

FIG. 8 shows the sleeves placed in the trays. Sleeve 12 is shown within bottom tray 21 and sleeve 33 has been placed within top tray 1.

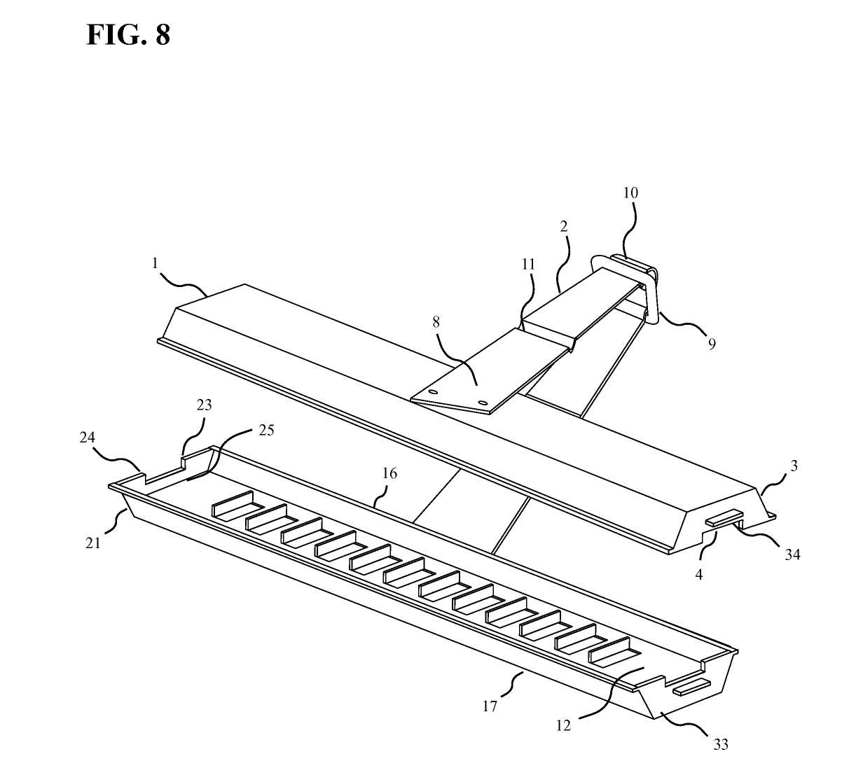

FIG. 9, FIG. 10, FIG. 11 and FIG. 12 illustrate use of a kebab de-skewer to de-skewer a kebab. As shown in FIG. 9, a user holds tong handle 2 of the kebab de-skewer in one hand and a skewer 50 with kebab pieces 51 in another hand. Then the user will place skewer 50 on bottom tray 21.

FIG. 10 shows that using tong handle 2, the user presses top tray 1 against kebab pieces 51 on skewer 50. Kebab pieces 51 pieces are now in the cavity between top tray 1 and bottom tray 21 and are securely kept in place by top tray 1 and tray extrusions within the tray sleeves within the trays.

FIG. 11 illustrates an optional step in which the user uses a short forward moving action that presses kebab pieces 51 against the front folded end of top tray 1 and bottom tray 21 and separates kebab pieces 51 from skewer 50. This forward motion of skewer 50 is a short distance, enough to get kebab pieces 51 in contact with the front folded edges of top tray 1 and bottom tray 21 and break the bond between kebab pieces 51 and skewer 50. This optional step is especially useful when the kebab pieces are composed of ground meat placed on a flat metal skewer (Koobideh Kabab).

As illustrated by FIG. 12, while grabbing the exposed end of skewer 50, the user will pull back skewer 50 with one hand and maintain pressure on tong handle 2 with the other hand. This action presses the back end of kebab pieces 51 against the back folded edge of top tray 1 and bottom tray 21 and breaks the bond between kebab pieces 51 and skewer 50 at this end as well. Now the bond between kebab pieces 51 and skewer 50 is broken at both ends so that further pulling of skewer 50 will with draw skewer 50 from kebab pieces 51, leaving kebab pieces 51 in place in the tray cavity between top tray 1 and bottom tray 21.

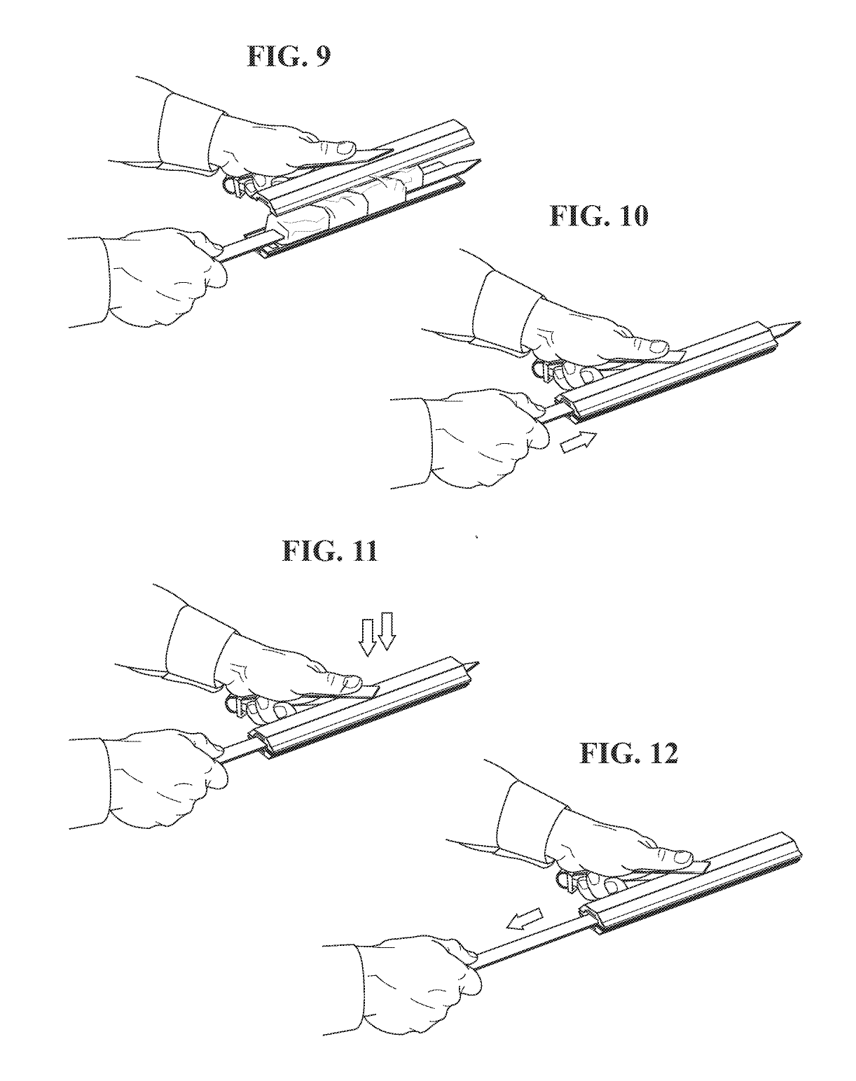

Top tray 1 and bottom tray 21, shown in FIG. 1, are approximately symmetrical. However, the top and bottom tray need not be symmetrical. For example, FIG. 13 shows a kebab de-skewer 40 where a top tray 61 is shorter than a bottom tray 41. Top tray 61, when closed, fits between side walls 43 of bottom tray 41. A skewer fits between slots 45 in side walls 43. Extrusions 62 on top tray 61 engage clumps of kebab pieces and holds the kebab pieces while de-skewering occurs. A user holds handle 42. Extrusions can be line strips or circular strips or any shape that is useful holding kebab pieces when the kebab pieces are removed from a skewer. Top tray 61 being shorter than bottom tray 41 allows for accommodation of different thicknesses of kebab pieces.

As shown in FIG. 13, bottom tray 41 has a back wall 48 but does not have a front wall. The absence of a front wall makes it easy to serve de-skewered kebab pieces by opening and tipping kebab de-skewer so that kebab pieces fall of the front of bottom tray 41 to a plate or serving platter.

FIG. 14 shows kebab de-skewer 40 in an open position, ready for receiving a skewer.

FIG. 15 shows kebab de-skewer 40 in a closed position, ready for de-skewering or storage. FIG. 16 shows a top view of kebab de-skewer 40.

Handle 42 is designed with a nonsymmetrical bend 49 in one tong side of handle 42. The purpose of nonsymmetrical bend 49 can be understood by comparing FIG. 2 with FIG. 14. In FIG. 2, handle 2 is connected to top tray 1 and bottom tray 21 at a 45 degree angle. The result is that when the kebab skewer is in the open position top tray 1 and bottom tray 21 are not opened in a parallel position relative to each other. Rather there is an acute angle between top tray 1 and bottom tray 21.

The non-symmetric bend 49 in a tong side of handle 42 can be made so that when kebab de-skewer 40 is in an open position, top tray 61 and bottom tray 41 are much closer to parallel. The angles associated with nonsymmetrical bend 49 can be selected for a better functionality such as improved gripping of kebab pieces. The two ends of the handle may have different nonsymmetrical angels.

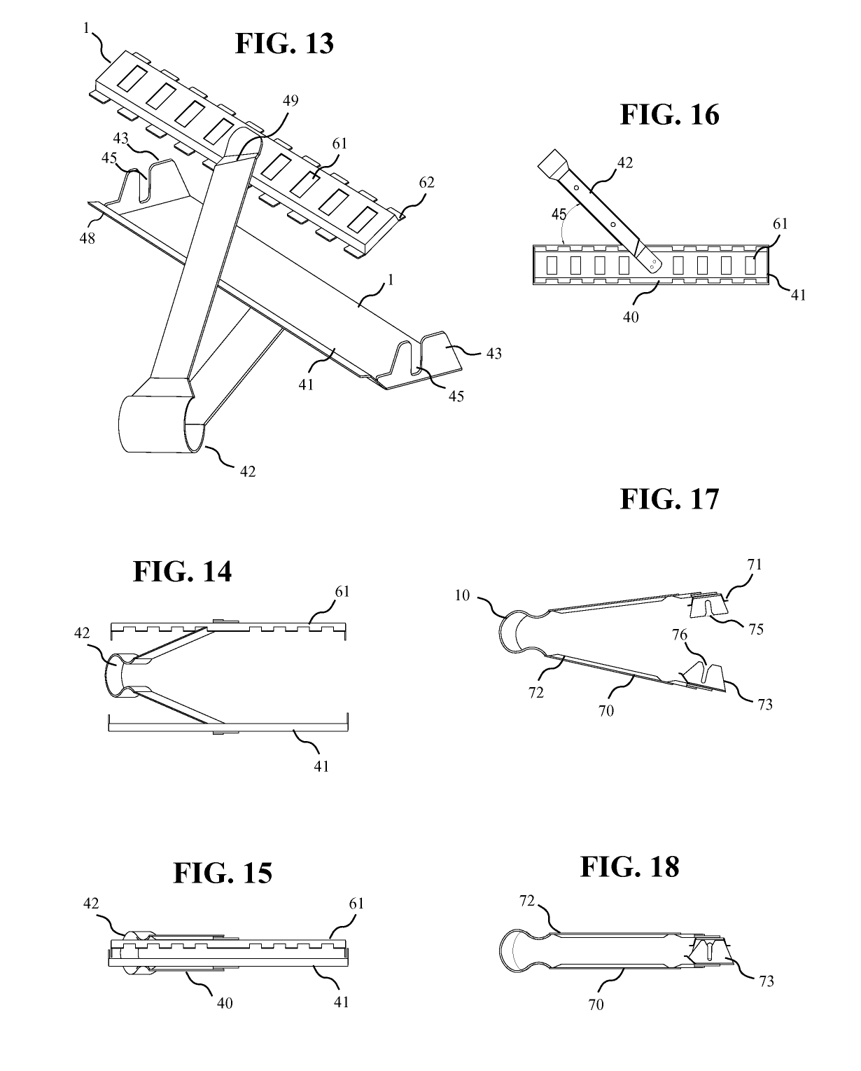

FIG. 17 shows a kebab de-skewer 70 with a handle 72, a top tray 71 and a bottom tray 73. Side walls in bottom tray 73 have a slot for 76 for receiving a skewer. Also side walls in top tray 71 have a slot 75 for receiving a skewer. FIG. 17 shows kebab de-skewer 70 in an open position, ready for receiving a skewer. FIG. 18 shows kebab de-skewer 70 in a closed position, ready for de-skewering or storage.

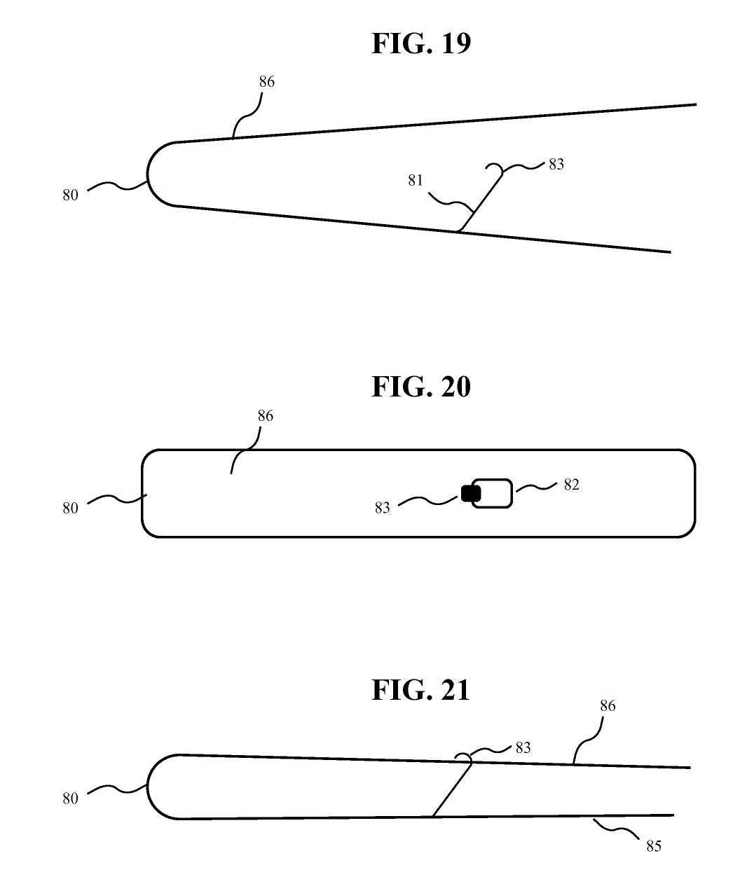

FIG. 19, FIG. 20 and FIG. 21 illustrate a tong locking mechanism. FIG. 19 shows a side view of a tong 80 when tong 80 is in an open position. Tong 80 has a hook 81 integrated on a tong side 85 of tong 80. FIG. 20 is a top view of tong 80 where an opening 82 in a tong side 86 of tong 80 allows a top 83 of hook 81 to be engaged with tong side 86 when tong 80 is in a locked position. FIG. 21 shows a side view of a tong 80 when tong 80 is in the locked position. Top 83 of hook 81 is shown to be engaged with tong side 86 when tong 80 is in the locked position. Hook 81 is located in front of a user handle area of tong 80 so as not to interfere with the user holding tong 80.

A kebab de-skewer such as that described in various embodiments above, simplifies pulling kebab pieces off a skewer. It is hygienic in that hands need not come in contact with kebab pieces. It is simple, quick and requires a minimum of effort. The shape of kebab pieces is generally maintained after de-skewering. The kebab de-skewer can alleviate food dropping during the process of pulling kebab pieces from a skewer. The kebab de-skewer is useful for all types of skewers, whether wooden, metal, round, flat, wide, narrow, long, short, and so on. There is no need to pre-prepare skewers before use; particularly, use of a kebab de-skewer alleviates the need to wet wooden skewers before use. The kebab de-skewer can be made from stainless material that is dish washable. It perfect for home use, picnics, backyard barbeques, tailgate parties and so on. It can also be used by professional chefs in restaurants and indoor/outdoor cooking outlets. It can be configured for use with any size skewer.

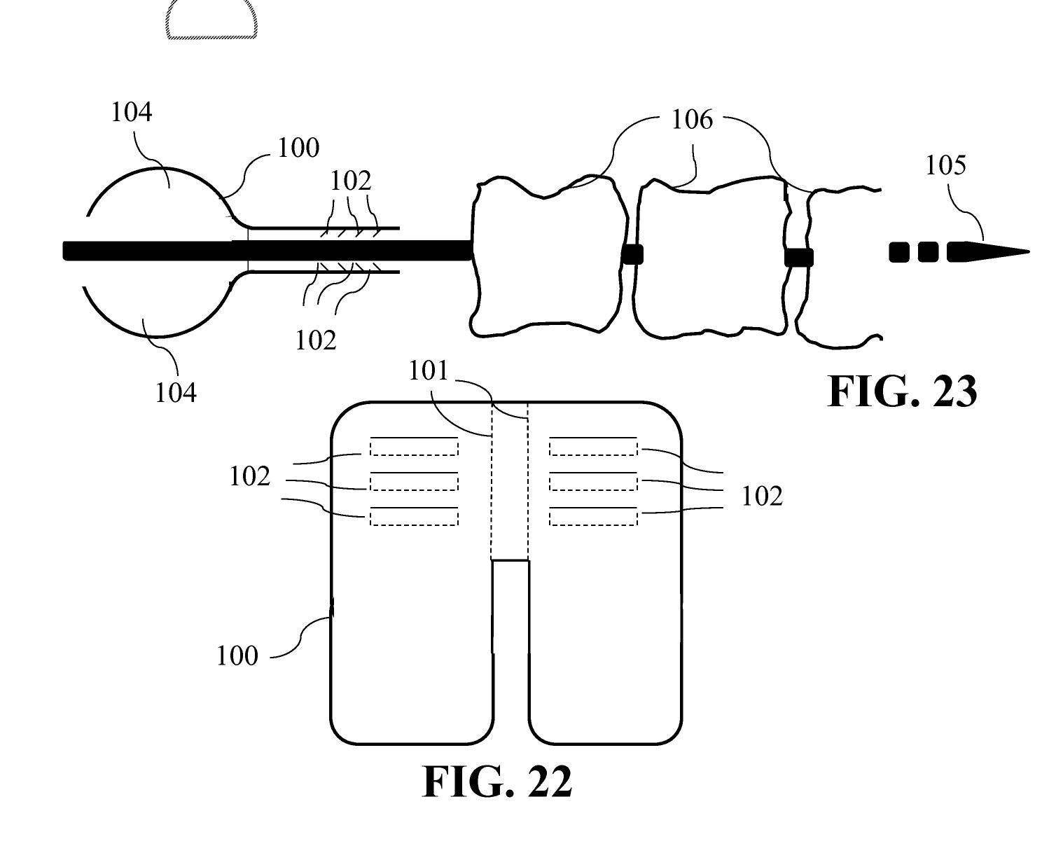

FIG. 22 shows a top (inner) unfolded view of a side folded skewer grip 100. A rough inner surface includes extrusions 102 that help grip a skewer. Extrusions 102 can be replaced by any kind of extrusions, spikes, line sharp barriers or other ways of creating a rough surface. Extrusions 102 can be attached to skewer grip 100 or skewer grip 100, can be punched through skewer grip 100, or molded to achieve the rough inner surface. Skewer grip 100 is manufactured from any suitable material such as fabric, metal, plastics, rubber, wood and so on. Fold lines 101 show were skewer grip 100 folds to grip a skewer.

FIG. 23 shows a cross section view of skewer grip 100 having been folded in position to hold a skewer 105. Extrusions 102 have come in contact with skewer 105 to prevent slipping. Skewer pieces 106 are shown mounted on skewer 105.

An outer convex surface 104 provide a convenient area for a user to hold onto skewer grip 100 and thus skewer 105. The resulting convex figure grip can be integrated as part of skewer grip 100 by folding or molding material. Alternatively, the outer convex surface 104 can be implemented as an external piece that is attached to skewer grip 100.

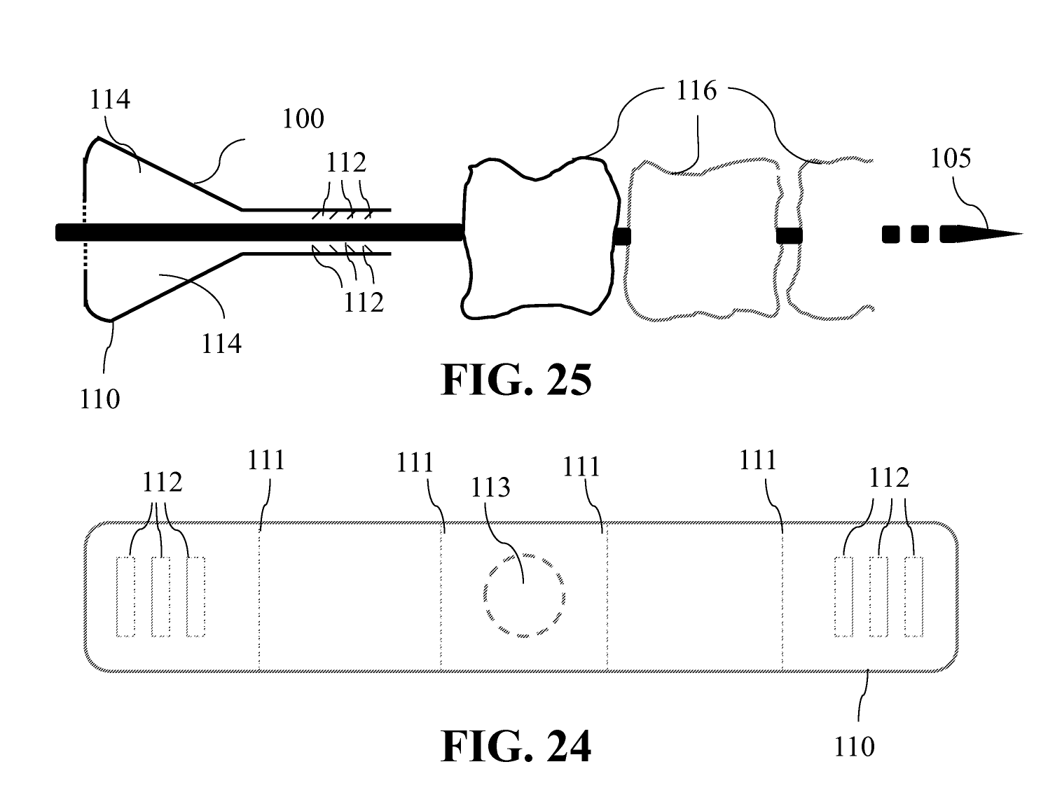

FIG. 24 shows a top (inner) unfolded view of a back folded skewer grip 110. A rough inner surface includes extrusions 112 that help grip a skewer. Extrusions 112 can be replaced by any kind of extrusions, spikes, line sharp barriers or other ways of creating a rough surface. This surface can be attached to skewer grip 110 or skewer grip 110 can be punched through or molded to achieve the rough inner surface. Skewer grip 110 is manufactured from any suitable material such as fabric, metal, plastics, rubber, wood and so on. Fold lines 111 show where skewer grip folds to grip a skewer placed through a skewer opening 113.

FIG. 25 shows a cross section view of a skewer grip 110 having been folded in position to hold a skewer 115. Skewer 115 extends through skewer opening 113. Extrusions 112 have come in contact with skewer 115 to prevent slipping. Skewer pieces 116 are shown mounted on skewer 115.

An outer convex surface 114 provide a convenient area for a user to hold onto skewer grip 110 and thus skewer 115. The resulting convex figure grip can be integrated as part of skewer grip 110 by folding or molding material. Alternatively, the outer convex surface 114 can be implemented as an external piece that is attached to skewer grip 110.

In both skewer grip designs illustrated in FIGS. 22 through 25, a user places a thumb and forefinger on either side of the skewer grip, places a skewer in the grip and on the inner rough surface portion where there is contact between the rough surface and the skewer. Once there is connection between the grip and the skewer and a firm grip is formed, the skewer can be pulled to help with the release of skewer pieces from the skewer.

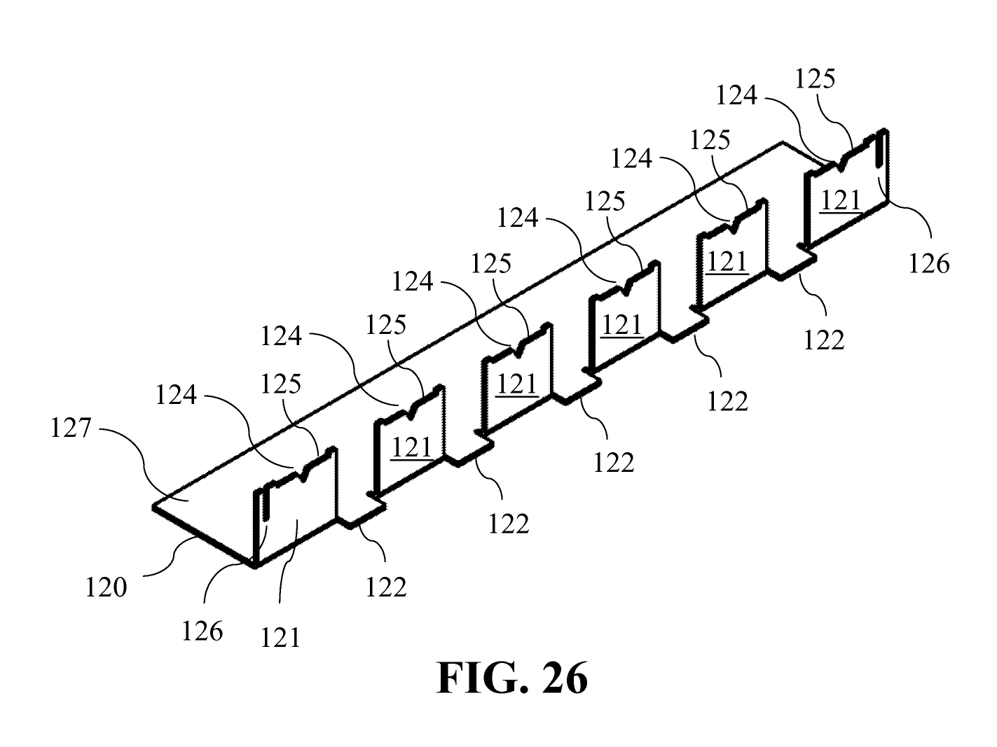

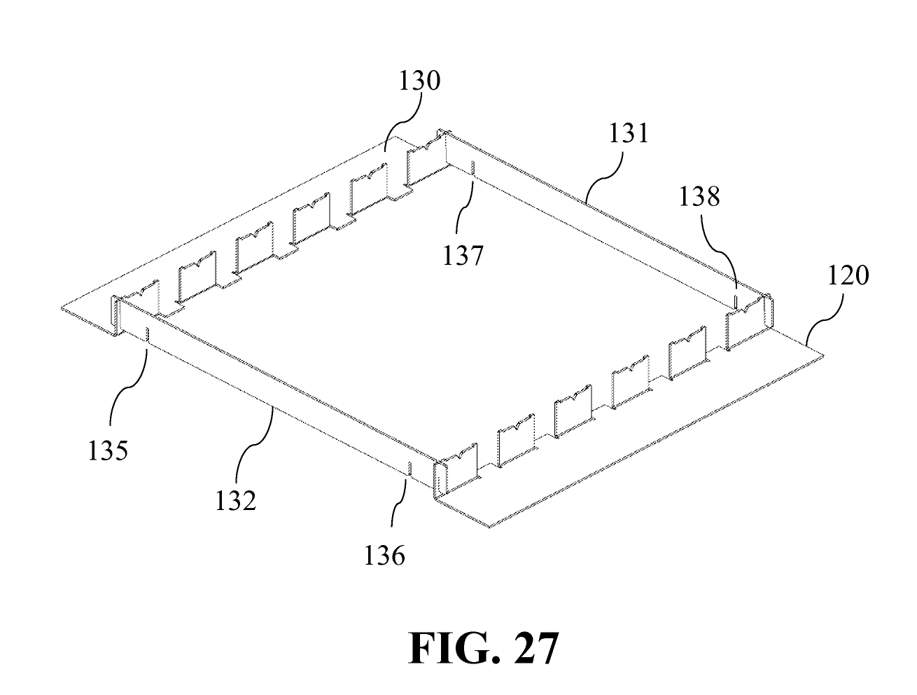

FIG. 26 and FIG. 27 show a skewer rack for placement over a cooking grate. The skewer rack is adjustable to support different size skewers.

The skewer rack has a front rack part and a back rack part that can be identical. For example, FIG. 26 shows a front (or back) rack part 120 that includes a bottom plate 127 to be placed on a cooking grate. Bottom plate 127 acts as a heat shield to protect ends of a skewer from being becoming overly heated or, if wooded, from burning. Each raised region 121 includes a notch 125 for holding a smaller diameter (wooden or metal) skewer and a notch 124 for holding a wider skewer. The notches can be shaped to match specific skewer shape. For example, notches can be shaped to match skewers with triangular cross section or rectangular cross section so that the skewers will fit snugly and not rotate during cooking. When a skewer is placed in the notches on raised regions 121, this keeps the skewed pieces from coming in contact with the cooking grate. The spaces in between notches 121 allow a kebab to be placed directly on the grate for cooking. In this case, bottom plate 127 is especially effective acting as a heat shield to protect ends of a skewer from being becoming overly heated or, if wooded, from burning.

At the side and bottom of each raised region 121 are a folded lip 122 and a notch 123. Slots 126 are used to connect rack part 120 to side plates. Folded lips 122 improve stability of the assembled racks. Folded lips 122 will prevent the rack from falling forward on the cooking grate in the case where the front or back part is not connected to a side part.

For example, FIG. 27 shows rack part 120 and an identical rack part 130 connected together by a side part 131 and a side part 132. Slots at the ends of side part 131 and side part 132 are used to make the connection allowing for barbequing with longer skewers. A slot 135, a slot 136, a slot 137 and a slot 138 can be used to connect rack part 120 to rack part 130 when shorter skewers are to be used for barbequing. Additional slots can be added in side part 131 and side part 132 to accommodate other size skewers.

Rack part 120 and rack part 130 can be used with or without side part 131 and side part 132. When used, side part 131 and side part 132 provide additional stability to rack part 120 and rack part 130 so they do not flip over with or without loaded skewers. Rack part 120 and an identical rack part 130 also protect the skewer ends from direct cooking grate heat exposure and prevent the skewer ends from heating up and/or burning.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

What is claimed is:

1. A kebab de-skewer, comprising:
a first tray sized to receive skewered kebab pieces;
a second tray; and,
a handle, connected to the first tray and the second tray, the handle, when in an open position, allowing enough separation between the first tray and the second tray so that a kebab can be loaded into the first tray, the handle when in a closed position, holding the second tray against skewered kebab pieces so that a user can remove a skewer from the skewered kebab pieces, leaving the kebab pieces in the first tray.

2. A kebab de-skewer as in claim 1 wherein the handle is a tong handle.

3. A kebab de-skewer as in claim 1 wherein the handle is a tong handle tong handle composed of a single piece of bent or formed material that has a spring as an inherent property of a bent end.

4. A kebab de-skewer as in claim 1 wherein the handle is a scissor type tong handle.

5. A kebab de-skewer as in claim 1 wherein the handle is a multi-piece spring-type tong that includes two tong sides connected together at one end and having a spring connected at another location between the two tong sides.

6. A kebab de-skewer as in claim 1 wherein the handle is a tong handle that has a locking mechanism that locks the tong in a closed position.

7. A kebab de-skewer as in claim 1 wherein the handle is a tong handle that has a locking mechanism that locks the tong in a closed position, the locking mechanism being an integrated hook on a first tong side that in the closed position is inserted through an opening on a second tong side and hook the second tong side.

8. A kebab de-skewer as in claim 1 wherein the handle is a tong handle that has a locking mechanism that locks the tong in a closed position, the locking mechanism being an o-ring that is in a first slot in the tong handle when the tong handle is in an open position, and is in a second slot in the tong handle when the tong handle is in the open position.

9. A kebab de-skewer as in claim 1 wherein the first tray and the second tray are symmetrical.

10. A kebab de-skewer as in claim 1 wherein at least one of the first tray and the second tray includes extrusions for holding the kebab pieces in place when the skewer is removed.

11. A kebab de-skewer as in claim 1 additionally comprising:
a sleeve, mounted in the first tray or the second tray, the sleeve including extrusions for holding the kebab pieces in place when the skewer is removed.

12. A kebab de-skewer as in claim 1 wherein the first tray includes a blocking wall at an end of the first tray, the blocking wall blocking the kebab pieces as the skewered is moved relative to the first tray.

13. A kebab de-skewer as in claim 1 wherein the first tray includes a blocking wall at an end of the first tray, the blocking wall blocking the kebab pieces as the skewered is moved relative to the first tray, the blocking wall including a slot of sufficient size to receive a skewer.

14. A kebab de-skewer as in claim 1 wherein the handle is a tong handle connected at an acute angle to the first tray and to the second tray, one tong side of the tong handle having a nonsymmetrical bend that increases parallelism between the first tray and the second tray when the kebab de-skewer is in an open position.

15. A kebab de-skewer as in claim 1:
wherein the first tray has a rectangular shape, with sides and ends being folded up; and,
wherein the second tray has a rectangular shape, with sides and ends being folded up so that when in a closed position, a cavity exists between the first tray and the second tray, the cavity being sized to hold skewered kebab pieces.

16. A kebab de-skewer as in claim 1 wherein the handle is connected to the first tray and the second tray at an acute angle.

17. A kebab de-skewer as in claim 1 wherein the second tray is shorter than the first tray.

18. A kebab de-skewer as in claim 1:
wherein the first tray has a rectangular shape, the first tray having a back wall but not a front wall.

19. A kebab de-skewer as in claim 1 wherein the handle is connected to the first tray and the second tray so that an angle of connection can be varied.

20. A skewer grip comprising:
an outer convex area for gripping by a user;
and inner region for contacting with a skewer, the inner region including extrusions for providing a firm grip on the skewer; and,
fold lines that allow folding of the skewer grip around the skewer.

21. A skewer grip as in claim 20 wherein the fold lines are situated on the skewer grip so that the skewer grip folds sideways around the skewer;

22. A skewer grip as in claim 20 wherein the fold lines are situated on the skewer grip so that the skewer grip folds front to back over the skewer;

23. A skewer grip as in claim 22 wherein the skewer grip includes a skewer opening through which the skewer may be placed.

24. A skewer rack comprising:
a front rack part having a plurality of elevated regions, each elevated region have a first notch for holding a smaller diameter skewer and a second notch for holding a wider skewer; and,
a back rack part having a plurality of elevated regions, each elevated region have a first notch for holding a smaller diameter skewer and a second notch for holding a wider skewer.

25. A skewer rack as in claim 24 additionally comprising:
a first side part that connects the first rack part to the second rack part; and,
a second side part that connects the first rack part to the second rack part.

26. A skewer rack as in claim 24 additionally comprising;
a plurality of lower regions between the elevated regions, the lower regions allowing a skewered kebab to supported by a cooking grate.

27. A skewer rack as in claim 24 wherein the front rack and the back rack each includes a heat shield that limits heat reaching ends of a skewer.

28. A skewer rack as in claim 24 wherein the front rack includes front tabs that prevent the front rack from falling forward on a grate and wherein the back rack includes front tabs that prevent the back rack from falling forward on the grate

29. A tong comprising:
a first tong;
a second tong;
a handle, connected to the first tong and the second tong; and,
a locking mechanism that locks the tong in a closed position, the locking mechanism being an integrated hook on the first tong that in the closed position is inserted through an opening on the second tong and hook the second tong.

30. A tong as in claim 29 wherein,
the integrated hook is integrated on the first tong by a weld.

31. A tong as in claim 29 wherein,
the integrated hook is integrated as a piece cut and extruded from the first tong.
